(19) United States
(12) Patent Application Publication
(10) Pub. No.: US 2026/0302249 A1
(43) Pub. Date: Oct. 1, 2026

(54) POSITIVE ELECTRODE FOR ALL-SOLID-STATE RECHARGEABLE BATTERIES AND ALL-SOLID-STATE RECHARGEABLE BATTERIES

(71) Applicant: SAMSUNG SDI CO., LTD., Yongin-si, Gyeonggi-do (KR)

(72) Inventors: Seulchan PARK, Yongin-si, Gyeonggi-do (KR); Myoungki MIN, Yongin-si, Gyeonggi-do (KR); Soomin HWANG, Yongin-si, Gyeonggi-do (KR); Jin-Woo KIM, Yongin-si, Gyeonggi-do (KR); Hoseon YOU, Yongin-si, Gyeonggi-do (KR); Juyun KIM, Yongin-si, Gyeonggi-do (KR)

(73) Assignee: SAMSUNG SDI CO., LTD., Yongin-si, Gyeonggi-do (KR)

(21) Appl. No.: 18/880,431

(22) PCT Filed: Jan. 8, 2024
(86) PCT No.: PCT/KR2024/000335

§ 371 Date: Dec. 31, 2024

(30) Foreign Application Priority Data
Jan. 31, 2023 (KR) 10-2023-0013207

(51) Int. Cl. H01M 4/62; H01M 4/02; H01M 4/13; H01M 10/0585

(52) U.S. Cl. CPC H01M 4/628; H01M 4/13; H01M 4/623; H01M 10/0585; H01M 2004/028

(57) ABSTRACT

Provided are a positive electrode for an all-solid-state rechargeable battery including a current collector and a positive electrode active material layer on the current collector, wherein the positive electrode active material layer includes a positive electrode active material, a sulfide-based solid electrolyte, a fluorine-based binder, a lithium salt, and a dispersion medium, and the dispersion medium includes a compound and an all-solid-state rechargeable battery.

### TECHNICAL FIELD

Positive electrodes for all-solid-state rechargeable batteries and all-solid-state rechargeable batteries including the same are disclosed.

### BACKGROUND ART

A portable information device such as a cell phone, a laptop, smart phone, and the like or an electric vehicle has used a rechargeable lithium battery having high energy density and easy portability as a driving power source. Recently, research has been actively conducted to use a rechargeable lithium battery with high energy density as a driving power source or power storage power source for hybrid or electric vehicles.

Because commercially available rechargeable lithium batteries use electrolyte solutions including flammable organic solvents, there are safety issues such as explosion or fire of the batteries in the event of collision, penetration, and the like. Accordingly, an all-solid-state rechargeable battery using a solid electrolyte instead of an electrolyte solution has been proposed. All-solid-state rechargeable batteries are batteries in which all materials are made of solid, and thus they are safe as there is no risk of electrolyte solution leaking and exploding, and have the advantage of being easy to manufacture thin batteries.

Such all-solid-state rechargeable batteries uses a positive electrode including a sulfide-based solid electrolyte with excellent ionic conductivity in addition to a positive electrode active material. In order to commercialize the all-solid-state batteries equipped with such a positive electrode, it should be possible to form the positive electrode through a wet coating process. However, such a sulfide-based solid electrolyte may be easily deteriorated by air, moisture, and a polar solvent or under a high temperature condition and thus have a problem of deteriorating performance of the all-solid-state batteries, which should be improved.

### DISCLOSURE

By lowering the resistance of the positive electrode for an all-solid-state rechargeable battery and increasing the lithium ionic conductivity, the initial charge/discharge characteristics and cycle-life characteristics of the all-solid-state rechargeable battery are improved.

In an embodiment, a positive electrode for an all-solid-state rechargeable battery includes a current collector and a positive electrode active material layer on the current collector, wherein the positive electrode active material layer includes a positive electrode active material, a sulfide-based solid electrolyte, a fluorine-based binder, a lithium salt, and a dispersion medium, wherein the dispersion medium includes a compound represented by Chemical Formula 1.

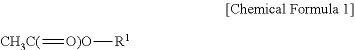

R¹ is a C7 to C9 alkyl group.

In another embodiment, an all-solid-state rechargeable battery includes the aforementioned positive electrode, a negative electrode, and a solid electrolyte layer between the positive electrode and the negative electrode.

According to an embodiment, a positive electrode for an all-solid-state rechargeable battery has high lithium ionic conductivity and low resistance, and by applying this, the all-solid-state rechargeable battery has improved overall performance, including initial charge/discharge characteristics and cycle-life characteristics.

### DESCRIPTION OF THE DRAWINGS

FIGS. 1 and 2 are cross-sectional views schematically showing all-solid-state rechargeable batteries according to embodiments.

FIG. 3 is a graph showing the initial charge/discharge characteristics of the all-solid-state rechargeable battery cells of Example 1, Example 2, and Comparative Example 2, and is a graph showing the voltage according to the specific capacity.

FIG. 4 is a graph showing cycle-life characteristics of the all-solid-state rechargeable battery cells of Examples 1 and 2 and Comparative Examples 1 and 2.

FIG. 5 is a graph showing the change in ionic conductivity according to the lithium salt content of a composite binder solvent and a reference binder solution.

FIG. 6 is a graph showing the ionic conductivity (left vertical axis) and electronic conductivity (right vertical axis) of the positive electrodes of Examples 1 and 2, and Comparative Example 1.

### BEST MODE

Hereinafter, specific embodiments will be described in detail so that those of ordinary skill in the art can easily implement them. However, this disclosure may be embodied in many different forms and is not construed as limited to the example embodiments set forth herein.

The terminology used herein is used to describe embodiments only, and is not intended to limit the present disclosure. The singular expression includes the plural expression unless the context clearly dictates otherwise.

As used herein, “combination thereof” means a mixture, a laminate, a composite, a copolymer, an alloy, a blend, a reaction product, and the like of the constituents.

Herein, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface.

The average particle diameter may be measured by a method well known to those skilled in the art, for example, may be measured by a particle size analyzer, or may be measured by a transmission electron microscope image or a scanning electron microscope image. Alternatively, it is possible to obtain an average particle diameter value by measuring using a dynamic light scattering method, performing data analysis, counting the number of particles for each particle size range, and calculating from this. Unless otherwise defined, the average particle diameter may mean the diameter (D50) of particles having a cumulative volume of 50 volume % in the particle size distribution. As used herein, when a definition is not otherwise provided, the average particle diameter means a diameter (D50) of particles having a cumulative volume of 50 volume % in the particle size distribution that is obtained by measuring the size (diameter or length of the major axis) of about 20 particles at random in a scanning electron microscope image.

Herein, “or” is not to be construed as an exclusive meaning, for example, “A or B” is construed to include A, B, A+B, and the like.

“Metal” is interpreted as a concept including ordinary metals, transition metals and metalloids (semi-metals).

### Positive Electrode

In an embodiment, a positive electrode for an all-solid-state rechargeable battery includes a current collector and a positive electrode active material layer on the current collector, wherein the positive electrode active material layer includes a positive electrode active material, a sulfide-based solid electrolyte, a fluorine-based binder, a lithium salt, and a dispersion medium, and the dispersion medium includes a compound represented by Chemical Formula 1.

In an embodiment, the fluorine-based binder and the lithium salt may be combined. A composite of a fluorine-based binder and a lithium salt may be a composite binder having high lithium ionic conductivity. In the positive electrode of an all-solid-state rechargeable battery, the sulfide-based solid electrolyte is vulnerable to moisture and has limited dispersibility, and thus the addition of an organic binder is essential. In particular, the development of organic binders that are applicable to wet processes and have high lithium ionic conductivity is becoming an important factor in the commercialization of all-solid-state rechargeable batteries. A composite of a fluorine-based binder and a lithium salt according to an embodiment of the present invention can effectively lower the resistance of the positive electrode while improving the dispersibility of the positive electrode active material and the sulfide-based solid electrolyte and suppressing the deterioration of the sulfide-based solid electrolyte. In addition, the dispersion medium according to an embodiment can promote the interaction between the fluorine-based binder and the lithium salt, and also has low reactivity with the sulfide-based solid electrolyte, thereby suppressing deterioration of the solid electrolyte. Ultimately, the fluorine-based binder and lithium salt interact within the dispersion medium to promote lithium ionization, and accordingly, the positive electrode including the same has reduced resistance and improved rate capability and cycle-life characteristics.

### Dispersive Medium

The dispersion medium includes a compound represented by Chemical Formula 1.

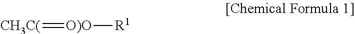

R¹ is a C7 to C9 alkyl group. That is, R¹ is an alkyl group having 7 to 9 carbon atoms. R¹ may be a linear alkyl group or a cyclic alkyl group, and may be a linear or branched alkyl group.

The compound represented by Chemical Formula 1 may be represented by a C7 to C9 alkyl acetate, and may be, for example, heptyl acetate, octyl acetate, or nonyl acetate. In Chemical Formula 1, R¹ may be, for example, a C7 to C8 alkyl group or a C8 to C9 alkyl group.

The dispersion medium is a nonpolar solvent that has very low reactivity with a sulfide-based solid electrolyte, does not increase cell resistance, and may also dissolve a fluorine-based binder well to achieve an appropriate viscosity, thereby enabling uniform coating on the electrode plate. In addition, the dispersion medium can help combination of the fluorine-based binder and the lithium salt and promote the interaction between the two, thereby promoting the ionization of lithium within the positive electrode, and increasing the lithium ionic conductivity of the positive electrode for an all-solid-state rechargeable battery.

Based on 100 wt % of the positive electrode active material layer, the compound represented by Chemical Formula 1 may be included in an amount of less than or equal to 0.1 wt %, for example, 0.0001 wt % to 0.1 wt %, 0.0001 wt % to 0.05 wt %, 0.0001 wt % to 0.04 wt %, 0.0001 wt % to 0.03 wt %, 0.0001 wt % to 0.02 wt %, 0.0001 wt % to 0.01 wt %, 0.001 wt % to 0.01 wt %, 0.001 wt % to 0.005 wt %, or 0.005 wt % to 0.01 wt %. The compound represented by Chemical Formula 1, which has been used as a type of dispersant in the positive electrode composition during positive electrode manufacturing, remains in this small amount in the final positive electrode active material layer.

### Fluorine-Based Binder

The fluorine-based binder may include, for example, polyvinylidene fluoride (PVdF), a polyvinylidene fluoride-hexafluoropropylene (PVdF-HFP) copolymer, a polyvinylidene fluoride-trichloroethylene (PVdF-TCE) copolymer, polytetrafluoroethylene (PTFE), polytrifluoroethylene (PTrFE), polychlorotrifluoroethylene (CTFE), tetrahexafluoropropylene, hexafluoroisobutylene, or a combination thereof.

For example, the fluorine-based binder may be a polyvinylidene fluoride-hexafluoropropylene (PVdF-HFP) copolymer. The binder is suitable for combining with a lithium salt and can effectively suppress deterioration due to moisture while improving the lithium ionic conductivity of a positive electrode for an all-solid-state rechargeable battery and increasing the dispersibility of a sulfide-based solid electrolyte.

The PVdF-HFP copolymer may include 70 mol % to 99 mol % of vinylidene fluoride units and 1 mol % to 30 mol % of hexafluoropropylene units, for example, 75 mol % to 85 mol % of vinylidene fluoride units and 15 mol % to 25 mol % of hexafluoropropylene units. These PVdF-HFP copolymers can contribute to lowering the resistance and increasing the lithium ionic conductivity of positive electrodes for all-solid-state rechargeable batteries while implementing excellent adhesive strength.

The fluorine-based binder may be included in an amount of 0.1 wt % to 5 wt %, for example, 0.1 wt % to 3 wt %, or 0.5 wt % to 2 wt % based on 100 wt % of the positive electrode active material layer.

### Lithium Salt

The lithium salt may include, for example, LiPF₆, LiBF₄, LiSbF₆, LiAsF₆, LiCsF₆, LiCl, LiF, LiBr, LiI, LiCF₃SO₃, LiClO₄, LiSCN, LiN(CN)₂, Li(CF₃SO₂)₃C, LiC₄F₉SO₃, LiN(SO₂CF₂CF₃)₂, LiB(C₂O₄)₂, LiBF₃(C₂F₅), lithium bis(oxalato) borate (LiBOB), lithium difluoro (oxalato) borate (LiDFOB), lithium bis(trifluoromethanesulfonyl)imide (LiTFSI), lithium bis(fluorosulfonyl)imide (LiFSI), or a combination thereof.

For example, the lithium salt may be an imide-based lithium salt. The imide-based lithium salt may specifically be lithium bis(trifluoromethanesulfonyl)imide (LiTFSI), lithium bis(fluorosulfonyl)imide (LiFSI), or a combination thereof. The imide-based lithium salt is suitable for combining with the fluorine-based binder and is advantageous in increasing the lithium ionic conductivity and lowering the resistance of positive electrodes for all-solid-state rechargeable batteries.

The lithium salt may be included in an amount of 10 parts by weight to 60 parts by weight, for example 30 parts by weight to 50 parts by weight, based on 100 parts by weight of the fluorine-based binder. When the lithium salt is included in the above range, effective combination with a fluorine-based binder can occur, thereby increasing the lithium ionic conductivity of the positive electrode for an all-solid-state rechargeable battery while lowering the resistance and improving the rate capability and cycle-life characteristics of the all-solid-state battery.

The lithium salt may be included in an amount of 0.01 wt % to 3 wt %, for example, 0.05 wt % to 2 wt %, or 0.1 wt % to 1 wt % based on 100 wt % of the positive electrode active material layer.

### Positive Electrode Active Material

The positive electrode active material may be applied without limitation as long as it is generally used in all-solid-state rechargeable batteries. For example, the positive electrode active material may be a compound being capable of intercalating and deintercalating lithium, and may include a compound represented by one of the following chemical formulas.

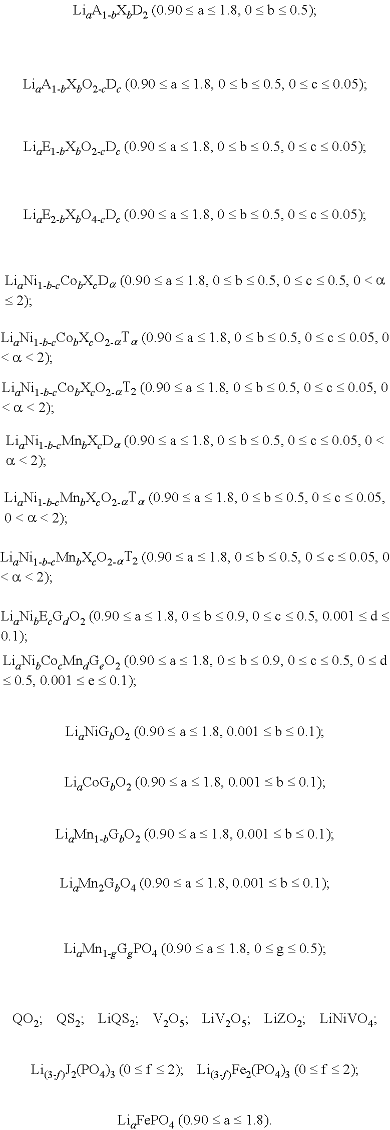

In the chemical formulas, A is selected from Ni, Co, Mn, and a combination thereof; X is selected from Al, Ni, Co, Mn, Cr, Fe, Mg, Sr, V, rare earth elements, and a combination thereof; D is selected from O, F, S, P, and a combination thereof; E is selected from Co, Mn, and a combination thereof; T is selected from F, S, P, and a combination thereof; G is selected from Al, Cr, Mn, Fe, Mg, La, Ce, Sr, V, and a combination thereof; Q is selected from Ti, Mo, Mn, and a combination thereof; Z is selected from Cr, V, Fe, Sc, Y, and a combination thereof; and J is selected from V, Cr, Mn, Co, Ni, Cu, and a combination thereof.

The positive electrode active material may be, for example, a lithium cobalt oxide (LCO), a lithium nickel oxide (LNO), a lithium nickel cobalt oxide (NC), a lithium nickel cobalt aluminum oxide (NCA), a lithium nickel cobalt manganese oxide (NCM), a lithium nickel manganese oxide (NM), a lithium manganese oxide (LMO), or lithium iron phosphate (LFP).

For example, the positive electrode active material may include lithium nickel-based oxide represented by Chemical Formula 11, lithium cobalt-based oxide represented by Chemical Formula 12, a lithium iron phosphate-based compound represented by Chemical Formula 13, and cobalt-free lithium nickel-manganese-based oxide represented by Chemical Formula 14, or a combination thereof.

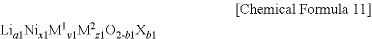

In Chemical Formula 11, 0.9≤a1≤1.8, 0.3≤x1≤1, 0≤y1≤0.7, 0≤z1≤0.7, 0.9≤x1+y1+z1≤1.1, 0≤b1≤0.1, M¹ and M² are one or more elements independently selected from Al, B, Ba, Ca, Ce, Co, Cr, Cu, Fe, Mg, Mn, Mo, Nb, Si, Sn, Sr, Ti, V, W, and Zr, and X is one or more elements selected from F, P, and S.

In Chemical Formula 11, 0.6≤x1≤1, 0≤y1≤0.4, and 0≤z1≤0.4 or 0.8≤x1≤1, 0≤y1≤0.2, and 0≤z1≤0.2.

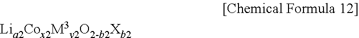

In Chemical Formula 12, 0.9≤a2≤1.8, 0.7≤x2≤1, 0≤y2≤0.3, 0.9≤x2+y2≤1.1, and 0≤b2≤0.1, M³ is one or more elements selected from Al, B, Ba, Ca, Ce, Cr, Cu, Fe, Mg, Mn, Mo, Ni, Se, Si, Sn, Sr, Ti, V, W, Y, Zn, and Zr, and X is one or more elements selected from F, P, and S.

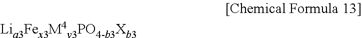

In Chemical Formula 13, 0.9≤a3≤1.8, 0.6≤x3≤1, 0≤y3≤0.4, and 0≤b3≤0.1, M⁴ is one or more elements selected from Al, B, Ba, Ca, Ce, Co, Cr, Cu, Mg, Mn, Mo, Ni, Se, Si, Sn, Sr, Ti, V, W, Y, Zn and Zr, and X is one or more elements selected from F, P, and S.

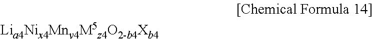

In Chemical Formula 14, 0.9≤a2≤1.8, 0.8≤x4≤1, 0<y4≤0.2, 0≤z4≤0.2, 0.9≤x4+y4+z4≤1.1, and 0≤b4≤0.1, M⁵ is one or more elements selected from Al, B, Ba, Ca, Ce, Cr, Fe, Mg, Mo, Nb, Si, Sn, Sr, Ti, V, W, and Zr, and X is one or more elements selected from F, P, and S.

An average particle diameter (D50) of the positive electrode active material may be 1 μm to 25 μm, for example 3 μm to 25 μm, 1 μm to 20 μm, 1 μm to 18 μm, 3 μm to 15 μm, or 5 μm to 15 μm. For example, the positive electrode active material may include small particles having an average particle diameter (D50) of 1 μm to 9 μm and large particles having an average particle diameter (D50) of 10 μm to 25 μm. The positive electrode active material having this particle size range can be harmoniously mixed with other components within the positive electrode active material layer and can achieve high capacity and high energy density. Here, the average particle diameter means a diameter (D50) of particles having a cumulative volume of 50 volume % in the particle size distribution that is obtained by measuring the size (diameter or length of the major axis) of about 20 particles at random in a scanning electron microscope image for positive electrode active materials.

The positive electrode active material may be in the form of secondary particles made by agglomerating a plurality of primary particles or in the form of single particles. Additionally, the positive electrode active material may have a spherical or close to spherical shape, or may have a polyhedral or irregular shape.

Meanwhile, the positive electrode active material may include a buffer layer on the surface of the particles. The buffer layer may be expressed as a coating layer, a protective layer, etc., and may serve to lower the interfacial resistance between the positive electrode active material and the sulfide-based solid electrolyte particles. For example, the buffer layer may include lithium-metal-oxide, wherein the metal may be for example one or more elements selected from Al, B, Ca, Ce, Cr, Fe, Mg, Mo, Nb, Si, Sn, Sr, Ta, V, W, and Zr. The lithium-metal-oxide improves the performance of the positive electrode active material by facilitating the movement of lithium ions and electronic conduction, and is improved for lowering the interfacial resistance between the positive electrode active material and solid electrolyte particles.

The positive electrode active material may be included in an amount of 55 wt % to 99 wt %, for example 65 wt % to 95 wt %, or 75 wt % to 91 wt % based on 100 wt % of the positive electrode active material layer.

### Solid Electrolyte

The solid electrolyte may be an inorganic solid electrolyte, such as a sulfide-based solid electrolyte or an oxide-based solid electrolyte.

In an embodiment, the solid electrolyte may be a sulfide-based solid electrolyte having excellent ionic conductivity. The sulfide-based solid electrolyte particles may include, for example, Li₂S—P₂S₅, Li₂S—P₂S₅—LiX (wherein X is a halogen element, for example I, or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (wherein m and n is each an integer and Z is Ge, Zn, or Ga), Li₂S—GeS₂, Li₂S—SiS₂—Li₃PO₄, Li₂S—SiS₂-LiₚMO_{q} (wherein p and q each an integer and M is P, Si, Ge, B, Al, Ga, or In), or a combination thereof.

Such a sulfide-based solid electrolyte may be obtained by, for example, mixing Li₂S and P₂S₅ in a molar ratio of 50:50 to 90:10 or 50:50 to 80:20 and optionally, performing heat treatment. Within the above mixing ratio range, a sulfide-based solid electrolyte having excellent ionic conductivity can be manufactured. Here, other components such as SiS₂, GeS₂, and B₂S₃ may be added to further improve the ionic conductivity.

Mechanical milling or a solution method may be applied as a mixing method of sulfur-containing raw materials for preparing a sulfide-based solid electrolyte. The mechanical milling is to make starting materials into particulates by putting the starting materials in a ball mill reactor and fervently stirring them. The solution method may be performed by mixing the starting materials in a solvent to obtain a solid electrolyte as a precipitate. In addition, in the case of heat treatment after mixing, crystals of the solid electrolyte may be more robust and ionic conductivity may be improved. For example, the sulfide-based solid electrolyte may be prepared by mixing sulfur-containing raw materials and performing heat treatment two or more times. In this case, a sulfide-based solid electrolyte having high ionic conductivity and robustness may be prepared.

The sulfide-based solid electrolyte particles according to an embodiment, for example, may be prepared through a first heat treatment of mixing sulfur-containing raw materials and firing at 120° C. to 350° C. and a second heat treatment of mixing the resultant of the first heat treatment and firing the same at 350° C. to 800° C. The first heat treatment and the second heat treatment may be performed in an inert gas or nitrogen atmosphere, respectively. The first heat treatment may be performed for 1 hour to 10 hours, and the second heat treatment may be performed for 5 hours to 20 hours. Small raw materials may be milled through the first heat treatment, and a final solid electrolyte can be synthesized through the second heat treatment. Through such two or more heat treatments, a sulfide-based solid electrolyte having high ionic conductivity and high performance can be obtained, and such a solid electrolyte may be suitable for mass production. The temperature of the first heat treatment may be, for example, 150° C. to 330° C., or 200° C. to 300° C., and the temperature of the second heat treatment may be, for example, 380° C. to 700° C., or 400° C. to 600° C.

For example, the sulfide-based solid electrolyte particles may include argyrodite-type sulfide. The argyrodite-type sulfide may be represented by, for example, a chemical formula of LiₐM_{b}P_{c}S_{d}Aₑ (wherein a, b, c, d, and e are all 0 or more and 12 or less, M is Ge, Sn, Si, or a combination thereof, and A is F, Cl, Br, or I), and as a specific example, may be represented by a chemical formula of Li₇₋ₓPS₆₋ₓAₓ (wherein x is 0.2 or more and 1.8 or less, and A is F, Cl, Br, or I). The argyrodite-type sulfide may specifically be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, etc.

The sulfide-based solid electrolyte particles including such an argyrodite-type sulfide-based solid electrolyte may have high ionic conductivity close to the range of 10⁻⁴ to 10⁻² S/cm, which is the ionic conductivity of general liquid electrolytes at room temperature, and may form an intimate bond between the positive electrode active material and the solid electrolyte without causing a decrease in ionic conductivity, and furthermore, an intimate interface between the electrode layer and the solid electrolyte layer. An all-solid-state rechargeable battery including this can have improved battery performances such as rate capability, coulombic efficiency, and cycle life characteristics.

The argyrodite-type sulfide-based solid electrolyte may be prepared, for example by mixing lithium sulfide and phosphorus sulfide, and optionally lithium halide. Heat treatment may be performed after mixing them. The heat treatment may include, for example, two or more heat treatment steps. Here, the preparing of the argyrodite-type sulfide-based solid electrolyte may include, for example, a first heat treatment in which raw materials are mixed and fired at 120° C. to 350° C., and a second heat treatment in which the resultant of the first heat treatment is mixed again and fired at 350° C. to 800° C.

The average particle size (D50) of the sulfide-based solid electrolyte particles may be, for example, 0.1 μm to 5.0 μm, and may be small particles of 0.1 μm to 1.9 μm or large particles of 2.0 μm to 5.0 μm. The average particle diameter of the sulfide-based solid electrolyte particles may be measured using an electron microscope image, and for example, a particle size distribution may be obtained by measuring the size (diameter or length of the major axis) of about 20 particles in a scanning electron microscope image, and D50 may be calculated therefrom.

The solid electrolyte may include an oxide-based inorganic solid electrolyte in addition to a sulfide-based material. The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr, Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (wherein M=Te, Nb, or Zr; and x is an integer of 1 to 10), or a mixture thereof.

The solid electrolyte is in the form of particles and may have an average particle diameter (D50) of less than or equal to 5.0 μm, for example, 0.1 μm to 5.0 μm, 0.5 μm to 5.0 μm, 0.5 μm to 4.0 μm, 0.5 μm to 3.0 μm, 0.5 μm to 2.0 μm, or 0.5 μm to 1.0 μm. These solid electrolytes can effectively penetrate between the positive electrode active materials, and have excellent contact with the positive electrode active materials and connectivity between the solid electrolyte particles.

The solid electrolyte may be included in an amount of 0.1 wt % to 35 wt %, for example 1 wt % to 35 wt %, 5 wt % to 30 wt %, 8 wt % to 25 wt %, or 10 wt % to 20 wt % based on 100 wt % of the positive electrode active material layer.

Additionally, the positive electrode active material may be included in an amount of 5 wt % to 99 wt % and the solid electrolyte may be included in an amount of 1 wt % to 35 wt %, for example the positive electrode active material may be included in an amount of 80 wt % to 90 wt %, and the solid electrolyte may be included in an amount of 10 wt % to 20 wt % based on a total weight of the positive electrode active material and solid electrolyte in the positive electrode active material layer. If the solid electrolyte is included in the positive electrode at such an amount, the efficiency and cycle-life characteristics of the all-solid-state battery can be improved without reducing the capacity.

### Conductive Material

The positive electrode active material layer may further include a conductive material. The conductive material is used to impart conductivity to the electrode, and any material that does not cause chemical change and conducts electrons can be used in the battery. Examples thereof may include a carbon-based material such as natural graphite, artificial graphite, carbon black, acetylene black, ketjen black, a carbon fiber, a carbon nanofiber, a carbon nanotube, and the like; a metal-based material including copper, nickel, aluminum, silver, etc. in a form of a metal powder or a metal fiber; a conductive polymer such as a polyphenylene derivative; or a mixture thereof.

A content of the conductive material in the positive electrode active material layer may be 0 wt % to 3 wt %, 0.01 wt % to 2 wt %, or 0.1 wt % to 1 wt % based on 100 wt % of the positive electrode active material layer.

The positive electrode current collector may include an aluminum foil, but is not limited thereto.

### All-Solid-State Rechargeable Battery

In an embodiment, an all-solid-state rechargeable battery includes the aforementioned positive electrode and a negative electrode and a solid electrolyte layer between the positive and negative electrodes.

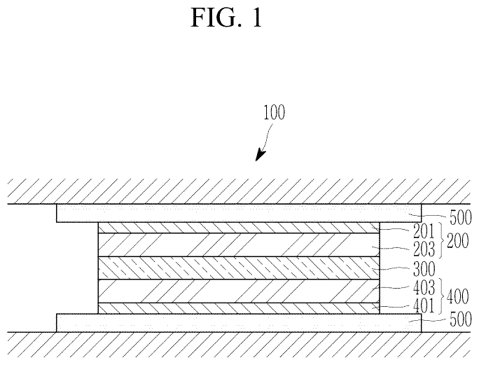

FIG. 1 is a cross-sectional view of an all-solid-state rechargeable battery according to an embodiment. Referring to FIG. 1, the all-solid-state rechargeable battery 100′ has a structure that an electrode assembly, in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked, is housed in a battery case. The all-solid-state rechargeable battery 100′ may further include at least one elastic layer 500 on the outside of at least either one of the positive electrode 200 and the negative electrode 400. Although FIG. 1 shows one electrode assembly including the negative electrode 400, the solid electrolyte layer 300, and the positive electrode 200, an all-solid-state rechargeable battery can also be manufactured by stacking two or more electrode assemblies.

### Negative Electrode

A negative electrode for an all-solid-state rechargeable battery includes a current collector and a negative electrode active material layer on the current collector. The negative electrode active material layer may include a negative electrode active material, may further include a binder and/or a conductive material.

The negative electrode active material includes a material that reversibly intercalates/deintercalates lithium ions, a lithium metal, a lithium metal alloy, a material capable of doping/dedoping lithium, or transition metal oxide.

The material that reversibly intercalates/deintercalates lithium ions may include, for example crystalline carbon, amorphous carbon, or a combination thereof as a carbon-based negative electrode active material. The crystalline carbon may be irregular, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy may include an alloy of lithium and one or more metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOₓ (0<x<2), a Si-Q alloy (wherein Q is an alkali metal, an alkaline-earth metal, a Group 13 element, a Group 14 element, a Group 15 element, a Group 16 element, a transition metal, a rare earth element, and a combination thereof, but not Si) and the Sn-based negative electrode active material may include Sn, SnO₂, a Sn—R alloy (wherein R is an alkali metal, an alkaline-earth metal, a Group 13 element, a Group 14 element, a Group 15 element, a Group 16 element, a transition metal, a rare earth element, and a combination thereof, but not Sn). At least one of these materials may be mixed with SiO₂. The elements Q and R may be selected from Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

For example, the negative electrode active material may include silicon-carbon composite particles. An average particle diameter (D50) of the silicon-carbon composite particles may be for example 0.5 μm to 20 μm. The average particle diameter (D50) is measured with a particle size analyzer and means a diameter of particles with a cumulative volume of 50 volume % in the particle size distribution. Silicon may be included in an amount of 10 wt % to 60 wt % and carbon may be included in an amount of 40 wt % to 90 wt % based on 100 wt % of the silicon-carbon composite particles. For example, the silicon-carbon composite particles may include a core including silicon particles, and a carbon coating layer on the surface of the core. An average particle diameter (D50) of the silicon particles may be 10 nm to 1 μm or 10 nm to 200 nm in the core. The silicon particles may exist as silicon alone, in the form of a silicon alloy, or in an oxidized form. The oxidized form of silicon may be represented by SiOₓ (0<x<2). In addition, a thickness of the carbon coating layer may be about 5 nm to 100 nm.

As an example, the silicon-carbon composite particles may include a core including silicon particles and crystalline carbon, and a carbon coating layer disposed on the surface of the core and including amorphous carbon. For example, in the silicon-carbon composite particles, amorphous carbon may not exist in the core but only in the carbon coating layer. The crystalline carbon may be artificial graphite, natural graphite, or a combination thereof, and the amorphous carbon may be may be formed from coal-based pitch, mesophase pitch, petroleum-based pitch, coal-based oil, heavy petroleum oil, or a polymer resin (phenolic resin, furan resin, polyimide, etc.). Herein, a content of the crystalline carbon may be 10 wt % to 70 wt % and a content of the amorphous carbon may be 20 wt % to 40 wt % based on 100 wt % of the silicon-carbon composite particles.

In the silicon-carbon composite particle, the core may include a void in the center. A radius of the void may be 30 length % to 50 length % of the radius of the silicon-carbon composite particle.

The aforementioned silicon-carbon composite particles effectively suppress problems such as volume expansion, structural collapse, or particle crushing due to charging and discharging, prevent disconnection of conductive paths, achieve high capacity and high efficiency, and is advantageous to use under a high-voltage or high-speed charging conditions.

The Si-based negative electrode active material or Sn-based negative electrode active material may be used by mixing with a carbon-based negative electrode active material. When using a mixture of Si-based negative electrode active material or Sn-based negative electrode active material and carbon-based negative electrode active material, a mixing ratio thereof may be 1:99 to 90:10 by weight.

A content of the negative electrode active material in the negative electrode active material layer may be 95 wt % to 99 wt % based on a total weight of the negative electrode active material layer.

In an embodiment, the negative electrode active material layer further includes the binder and optionally may further include the conductive material. A content of the binder in the negative electrode active material layer may be 1 wt % to 5 wt % based on a total weight of the negative electrode active material layer. In addition, if a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to well adhere the negative electrode active material particles to each other and also to adhere the negative electrode active material to the current collector. The binder may be a water-insoluble binder, a water-soluble binder, or a combination thereof.

The water-insoluble binder may be polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

The water-soluble binder may include a rubber-based binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluororubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a cellulose-based compound capable of imparting viscosity as a type of thickener may be further included. As this cellulose-based compound, one or more types of carboxymethyl cellulose, hydroxypropylmethyl cellulose, methyl cellulose, or an alkali metal salt thereof may be used. The alkali metal may be Na, K, or Li. The amount of the thickener used may be 0.1 parts by weight to 3 parts by weight based on 100 parts by weight of the negative electrode active material.

The conductive material is used to impart conductivity to the electrode, and any material that does not cause chemical change and conducts electrons can be used in the battery. Examples of the conductive material may include a carbon-based material such as natural graphite, artificial graphite, carbon black, acetylene black, ketjen black, a carbon fiber, a carbon nanofiber, a carbon nanotube, and the like; a metal-based material of a metal powder or a metal fiber including copper, nickel, aluminum, silver, and the like; a conductive polymer such as a polyphenylene derivative; or a mixture thereof.

The negative electrode current collector may include one selected from a copper foil, a nickel foil, a stainless steel foil, a titanium foil, a nickel foam, a copper foam, a polymer substrate coated with a conductive metal, and a combination thereof.

As another example, the negative electrode for an all-solid-state rechargeable battery may be a precipitation-type negative electrode. The precipitation-type negative electrode does not include a negative electrode active material during battery assembly, but may refer to a negative electrode in which lithium metal, etc. is precipitated or electrodeposited on the negative electrode during battery charging, thereby serving as a negative electrode active material.

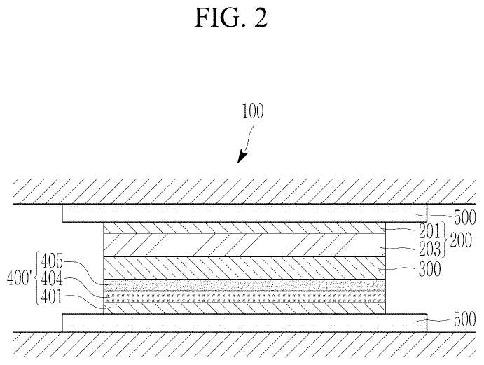

FIG. 2 is a schematic cross-sectional view of an all-solid-state rechargeable battery including a precipitation-type negative electrode. Referring to FIG. 2, the precipitation-type negative electrode 400′ may include a current collector 401 and a negative electrode coating layer 405 on the current collector. In an all-solid-state rechargeable battery having such a precipitation-type negative electrode 400′, initial charging begins in the absence of negative electrode active material, and during charging, high-density lithium metal is precipitated or electrodeposited between the current collector 401 and the negative electrode coating layer 405 or on the negative electrode coating layer 405 to form a lithium metal layer 404, which can serve as a negative electrode active material. Accordingly, in an all-solid-state rechargeable battery that has been charged at least once, the precipitation-type negative electrode 400′ may include, for example, a current collector 401, a lithium metal layer 404 on the current collector, and a negative electrode coating layer 405 on the metal layer. The lithium metal layer 404 may be referred to as a layer in which lithium metal, etc. is precipitated during the charging process of the battery, and may be referred to as a metal layer, lithium layer, lithium electrodeposition layer, or negative electrode active material layer.

The negative electrode coating layer 405 may also be referred to as a lithium electrodeposition inducing layer or a negative electrode catalyst layer, and may include a metal, a carbon material, or a combination thereof that acts as a catalyst.

The metal may be a lithiophilic metal and may include, for example, gold, platinum, palladium, silicon, silver, aluminum, bismuth, tin, zinc, or a combination thereof, and may be composed of one of these or various types of alloys. If the metal is present in particle form, an average particle diameter (D50) thereof may be less than or equal to about 4 μm, for example, 10 nm to 4 μm.

The carbon material may be, for example, crystalline carbon, amorphous carbon, or a combination thereof. The crystalline carbon may be for example natural graphite, artificial graphite, mesophase carbon microbeads, or a combination thereof. The amorphous carbon may be for example carbon black, activated carbon, acetylene black, denka black, ketjen black, or a combination thereof.

If the negative electrode coating layer 405 includes the metal and the carbon material, the metal and the carbon material may be, for example, mixed in a weight ratio of 1:10 to 2:1. Here, the precipitation of the lithium metal may be effectively promoted and improve characteristics of the all-solid-state rechargeable battery. The negative electrode coating layer 405 may include, for example, a carbon material on which a catalyst metal is supported or a mixture of metal particles and carbon material particles.

The negative electrode coating layer 405 may include, for example the lithiophilic metal and amorphous carbon, and in this case, the deposition of lithium metal may be effectively promoted. As a specific example, the negative electrode coating layer 405 may include a composite in which a lithiophilic metal is supported on amorphous carbon.

The negative electrode coating layer 405 may further include a binder, and the binder may be, for example, a conductive binder. Additionally, the negative electrode coating layer 405 may further include general additives such as a filler, a dispersant, an ion conductive agent, and the like.

A thickness of the negative electrode coating layer 405 may be for example 100 nm to 20 μm, 500 nm to 10 μm, or 1 μm m to 5 μm.

The precipitation-type negative electrode 400′ may further include a thin film, for example, on the surface of the current collector, that is, between the current collector and the negative electrode catalyst layer. The thin film may include an element capable of forming an alloy with lithium. The element capable of forming an alloy with lithium may be, for example, gold, silver, zinc, tin, indium, silicon, aluminum, bismuth, and the like, which may be used alone or an alloy of more than one. The thin film may further planarize a precipitation shape of the lithium metal layer 404 and much improve characteristics of the all-solid-state rechargeable battery. The thin film may be formed, for example in a vacuum deposition method, a sputtering method, a plating method, and the like.

The thin film may have, for example, a thickness of 1 nm to 500 nm. The lithium metal layer 404 may include lithium metal or lithium alloy. For example, the lithium alloy may be Li—Al alloy, Li—Sn alloy, Li—In alloy, Li—Ag alloy, Li—Au alloy, Li—Zn alloy, Li—Ge alloy, or Li—Si alloy.

A thickness of the lithium metal layer 404 may be 1 μm to 500 μm, 1 μm to 200 μm, 1 μm to 100 μm, or 1 μm to 50 μm. If the thickness of the lithium metal layer 404 is too thin, it is difficult to perform the role of a lithium storage, and if it is too thick, the battery volume may increase and performance may deteriorate.

When applying such a precipitation-type negative electrode, the negative electrode coating layer 405 may serve to protect the lithium metal layer 404 and suppress the precipitation growth of lithium dendrite. Accordingly, short circuit and capacity degradation of the all-solid-state battery may be suppressed and cycle-life characteristics can be improved.

### Solid Electrolyte Layer

The solid electrolyte layer 300 may include a sulfide-based solid electrolyte, an oxide-based solid electrolyte, etc. The contents of the sulfide-based solid electrolyte and oxide-based solid electrolyte are omitted as they are the same as those described above.

Meanwhile, the average particle diameter (D50) of the solid electrolyte included in the solid electrolyte layer 300 may be larger than the average particle diameter (D50) of the solid electrolyte included in the positive electrode 200. In this case, the energy density of the all-solid-state rechargeable battery may be maximized while increasing the mobility of lithium ions to improve the overall performance. For example, the average particle diameter (D50) of the solid electrolyte included in the positive electrode 200 may be 0.1 μm to 1.9 μm, or 0.1 μm to 1.0 μm, and the average particle diameter (D50) of the solid electrolyte included in the solid electrolyte layer 300 may be 2.0 μm to 5.0 μm, or 2.0 μm to 4.0 μm, or 2.5 μm to 3.5 μm. When this particle size range is satisfied, the energy density of the all-solid-state rechargeable battery may be maximized while the transfer of lithium ions is facilitated, thereby suppressing resistance and improving the overall performance of the all-solid-state rechargeable battery. Here, the average particle diameter (D50) of the solid electrolyte can be measured using a particle size analyzer using laser diffraction.

The solid electrolyte layer may further include a binder in addition to the solid electrolyte. At this time, the binder may be a styrene butadiene rubber, polytetrafluoroethylene, polyvinylidene fluoride, polyethylene, acrylate polymers or a combination thereof, but is not limited thereto, and any binder used in the relevant technical field can be used. The acrylate-based polymer may be, for example, butyl acrylate, polyacrylate, polymethacrylate or a combination thereof.

The solid electrolyte layer may be formed by adding a solid electrolyte to a binder solution, coating the same on a base film, and drying. The solvent of the binder solution may be isobutyryl isobutyrate, xylene, toluene, benzene, hexane, or a combination thereof. Because the solid electrolyte layer formation process is widely known in the art, a detailed description will be omitted.

The thickness of the solid electrolyte layer may be, for example, 10 μm to 150 μm.

The solid electrolyte layer may further include an alkali metal salt, and/or an ionic liquid, and/or a conductive polymer.

For example, the alkali metal salt may be lithium salt. The content of lithium salt in the solid electrolyte layer may be greater than or equal to 1 M or for example 1 M to 4 M. In this case, the lithium salt can improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LiF, LiBr, LiI, LiB(C₂O₄)₂, LiBF₄, LiBF₃(C₂F₅), lithium bis(oxalato)borate (LiBOB), lithium oxalyldifluoroborate (LIODFB), lithium difluoro(oxalato)borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄, or a mixture thereof.

In addition, the lithium salt may be an imide-based lithium salt, and for example, the imide-based lithium salt may include lithium bis(trifluoro methanesulfonyl)imide (LiTFSI, LiN(SO₂CF₃)₂), lithium bis(fluorosulfonyl)imide (LiFSI, LiN(SO₂F)₂). The lithium salt can maintain or improve ionic conductivity by maintaining appropriate chemical reactivity with ionic liquid.

The ionic liquid has a melting point below room temperature, so it is in a liquid state at room temperature and refers to a salt or room temperature molten salt composed of ions alone.

The ionic liquid may be a compound including a) at least one cation selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, or triazolium-based cation, and a mixture thereof, and b) at least one anion selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, (FSO₂)₂N—, (C₂F₅SO₂)2N—, (C₂F₅SO₂)(CF₃SO₂)N—, and (CF₃SO₂)₂N—.

The ionic liquid may be, for example, one or more selected from N-methyl-N-propylpyrrolidinium bis(trifluoromethanesulfonyl)imide N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

In the solid electrolyte layer, a weight ratio of the solid electrolyte and the ionic liquid in the solid electrolyte membrane may be 0.1:99.9 to 90:10, for example 10:90 to 90:10, 20:80 to 90:10, 30:70 to 90:10, 40:60 to 90:10, or 50:50 to 90:10. The solid electrolyte layer satisfying the above ranges may maintain or improve ionic conductivity by improving the electrochemical contact area with the electrode. Accordingly, the energy density, discharge capacity, rate capability, etc. of the all-solid-state rechargeable battery may be improved.

The all-solid-state rechargeable battery may be a unit cell with a structure of positive electrode/solid electrolyte layer/negative electrode, a bicell with a structure of positive electrode/solid electrolyte layer/negative electrode/solid electrolyte layer/positive electrode, or a stacked battery in which the structure of the unit cell is repeated.

The shape of the all-solid-state rechargeable battery is not particularly limited, and may be, for example, coin-shaped, button-shaped, sheet-shaped, stacked-shaped, cylindrical, flat, etc. In addition, the all-solid-state rechargeable battery may be applied to a large-sized battery used in an electric vehicle or the like. For example, the all-solid-state rechargeable battery may also be used in hybrid vehicles such as plug-in hybrid electric vehicles (PHEV). In addition, it may be used in a field requiring a large amount of power storage, and may be used, for example, in an electric bicycle or a power tool. In addition, the all-solid-state rechargeable battery may be used in various fields such as portable electronic devices.

### MODE FOR INVENTION

Hereinafter, examples and comparative examples of the present invention will be described. The following examples are only examples of the present invention and the present invention is not limited to the following examples.

### Example 1

### 1. Preparation of Binder Solution

0.8 g of PVdF-HFP and 0.24 g of LiTFSI were added to 9.2 g of octyl acetate to prepare a binder solution. Herein, PVdF-HFP and LiTFSI had a weight ratio of 100:30.

### 2. Manufacturing of Positive Electrode

A positive electrode composition was prepared by mixing a positive electrode active material of LiNi_{0.9}Co_{0.05}Mn_{0.05}O₂ coated with Li₂O—ZrO₂, an argyrodite-type solid electrolyte of Li₆PS₅Cl, the prepared binder solution, and a conductive material of carbon nanotube. Herein, 85 wt % of the positive electrode active material, 13.5 wt % of the solid electrolyte, 1.0 wt % of PVdF-HFP, 0.3 wt % of LiTFSI, and 0.2 wt % of the conductive material were mixed.

The prepared positive electrode composition was coated on a positive electrode current collector with a bar coater and then, dried in a convection oven at 80° C. for 10 minutes, manufacturing a positive electrode having a positive electrode active material layer on the current collector.

### 3. Manufacturing of Solid Electrolyte Layer

A solid electrolyte layer composition was prepared by mixing an acrylic binder (SX-A334, Zeon Corp.) in an isobutyryl isobutyrate (IBIB) solvent to prepare a binder solution and adding an argyrodite-type solid electrolyte Li₆PS₅Cl (D50=3 μm) to the binder solution. The composition included 98.5 wt % of the solid electrolyte and 1.5 wt % of the binder. The composition was coated on a release PET film with a bar coater and then, dried at room temperature to form a solid electrolyte layer.

### 4. Manufacturing of Negative Electrode

After preparing an Ag/C composite by mixing carbon black with a primary particle diameter (D50) of about 30 nm and silver (Ag) with an average particle diameter (D50) of about 60 nm in a weight ratio of 3:1, 0.25 g of the composite was added to 2 g of an NMP solution including 7 wt % of a polyvinylidene fluoride binder and then, mixed to prepare a negative electrode coating layer composition. The negative electrode coating layer composition was coated on a nickel foil current collector with a bar coater and then, vacuum-dried to prepare a precipitation-type negative electrode having a negative electrode coating layer on the current collector.

5. Manufacturing of all-Solid-State Rechargeable Battery Cell

The manufactured positive electrode, negative electrode, and solid electrolyte layer were cut to stack the solid electrolyte layer on the positive electrode and then, the negative electrode was stacked on the solid electrolyte layer. The obtained stack was sealed into a pouch shape, heat-treated at a high temperature of 85° C. under 500 Mpa for 30 minutes, and subjected to warm isostatic press (WIP), manufacturing an all-solid-state rechargeable battery cell.

### Example 2

A positive electrode and an all-solid-state rechargeable battery cell were manufactured substantially in the same manner as in Example 1 except that the binder solution was prepared to include PVdF-HFP and LiTFSI in a weight ratio of 100:50 by mixing 0.8 g of PVdF-HFP and 0.4 g of LiTFSI with 9.2 g of octyl acetate.

### Example 3

A positive electrode and an all-solid-state rechargeable battery cell were manufactured substantially in the same manner as in Example 1 except that the binder solution was prepared by using LiBF₄ instead of LiTFSI.

### Comparative Example 1

A positive electrode and an all-solid-state rechargeable battery cell were manufactured substantially in the same manner as in Example 1 except that the binder solution was prepared by not adding LiTFSI.

### Comparative Example 2

A positive electrode and an all-solid-state rechargeable battery cell were manufactured substantially in the same manner as in Example 1 except that the binder solution was prepared to include PVdF-HFP and LiTFSI in a weight ratio of 100:70 by adding 0.8 g of PVdF-HFP and 0.56 g of LiTFSI to 9.2 g of octyl acetate.

### Comparative Example 3

A positive electrode and an all-solid-state rechargeable battery cell were manufactured substantially in the same manner as in Example 1 except that the binder solution was prepared by using isobutyryl isobutyrate instead of the octyl acetate.

### Evaluation Example 1: Initial Charge and Discharge Performance Evaluation

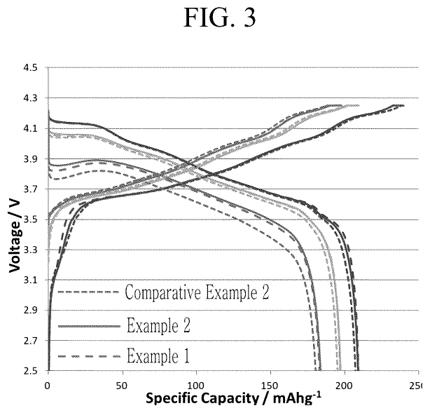

The all-solid-state rechargeable battery cells according to Examples 1 and 2, and Comparative Example 2 were evaluated with respect to initial charge and discharge performance, which was shown as a voltage graph according to specific capacity in FIG. 3.

Each battery cell was charged to an upper limit voltage of 4.25 V at a constant current of 0.1 C and discharged to a cut-off voltage of 2.5 V at 0.1 C at 45° C. for initial charge and discharge (a red graph of FIG. 3). Subsequently, a second cycle proceeded by charging the cells at 0.1 C and discharging them at 0.33 C within the same voltage range as above (an orange graph of FIG. 3).

Then, a third cycle a second cycle proceeded by charging the cells at 0.1 C and discharging them at 1.0 C within the same voltage range as above (a green graph of FIG. 3).

Referring to FIG. 3, in all the first to third cycles, the cell of Comparative Example 2 exhibited much higher battery resistance. It is understood that cell performance was maximized, when a concentration of lithium salt was in a range of 30 parts by weight to 50 parts by weight based on 100 parts by weight of a polymer.

### Evaluation Example 2: Evaluation of Cycle-Life Characteristics

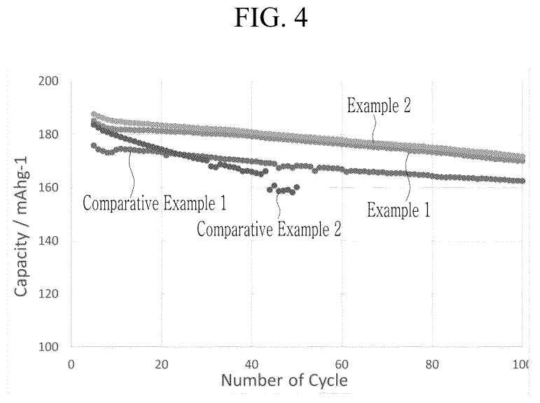

The all-solid-state rechargeable battery cells of Examples 1 and 2 and Comparative Examples 1 and 2 were 100 times or more repeatedly charged and discharged at 0.33 C within a voltage range of 2.5 V to 4.25 V after the same initial charge and discharge as in Evaluation Example 1 to evaluate cycle-life characteristics, and FIG. 4 shows a specific capacity (mAh/g) graph according to the number of cycles.

Referring to FIG. 4, Examples 1 and 2 exhibited much more excellent cycle-life characteristics than Comparative Examples 1 and 2, which confirmed that the improved battery performance by using the binder solution of the examples was maintained for more than 100 cycles.

### Evaluation Example 3: Ionic Conductivity of Binder Solution

A cell performance change according to a salt concentration suggests that a polymer plays a major role in activating the lithium salt. In other words, it may be understood that the PVdF-HFP polymer interacts with the LiTFSI salt and helps ionization of the salt. In order to support this, the LiTFSI solution was analyzed with respect to an ionic conductivity change according to presence or absence of the polymer.

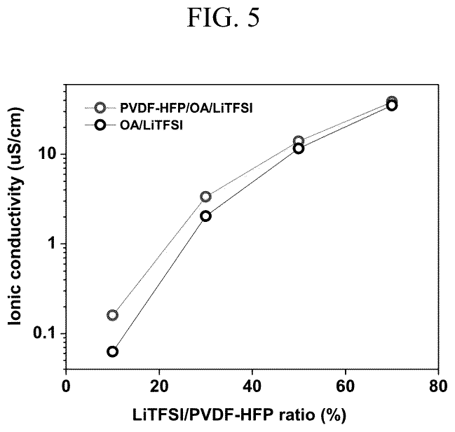

The composite binder solution, which was basically prepared by mixing PVdF-HFP, LiTFSI, and octyl acetate, was prepared to have different LiTFSI contents of 10 parts by weight, 30 parts by weight, 50 parts by weight, and 70 parts by weight but equally 1150 parts by weight of octyl acetate based on 100 parts by weight of PVdF-HFP. In addition, a reference example binder solution was prepared by equally adding LiTFSI but not adding PVdF-HFP to octyl acetate. The prepared solutions were measured with respect to ionic conductivity (μS/cm), and FIG. 5 shows an ionic conductivity change to a LiTFSI content.

Herein, the ionic conductivity was measured through electrochemical impedance spectroscopy (EIS) by injecting each of the prepared solutions to a torque cell. EIS was performed at an amplitude of about 10 mV within a frequency range of 0.1 Hz to 106 Hz under an air atmosphere at 25° C. Through EIS, an Nyquist plot was obtained, and then, a circular arc of the Nyquist plot was used to obtain resistance, which was used with a thickness, an area, and the like of the torque cell to calculate the ionic conductivity.

Referring to FIG. 5, at the various LiTFSI contents, compared with that the reference example binder solution including no PVdF-HFP, the composite binder solution including PVdF-HFP and LiTFSI exhibited slightly increased ionic conductivity. Furthermore, the higher concentration of the lithium salt to the polymer, the less corresponding effect. This suggests that when the polymer and the lithium salt are present in an appropriate ratio in the octyl acetate solution, the complexation effectively occurrs.

### Evaluation Example 4: Evaluation of Ionic Conductivity and Electronic Conductivity

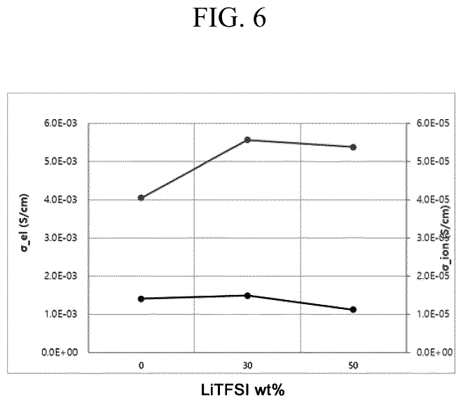

The positive electrodes according to Examples 1 and 2 and Comparative Example 1 were respectively used to manufacture symmetric ion blocking cells to proceed with an impedance analysis on a positive electrode plate. The positive electrode plate is a mixed conductor capable of simultaneous transport of electrons and ions, for which an equivalent circuit corresponds may be designed. Through the impedance analysis, a Nyquist plot was obtained and then, used to extract electronic conductivity and ionic conductivity of the positive electrode plate, and the results are shown in FIG. 6. In FIG. 6, a left vertical axis represents the electronic conductivity, and a right vertical axis represents ionic conductivity. Referring to FIG. 6, the positive electrode plate of Examples 1 and 2 exhibited all excellent ionic conductivity and electronic conductivity.

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

### DESCRIPTION OF SYMBOLS

100: all-solid-state battery
200: positive electrode
201: positive electrode current collector
203: positive electrode active material layer
300: solid electrolyte layer
400: negative electrode
401: negative electrode current collector
403: negative electrode active material layer
400': precipitation-type negative electrode
404: lithium metal layer
405: negative electrode coating layer
500: elastic layer

1. A positive electrode for an all-solid-state rechargeable battery, comprising
a current collector and a positive electrode active material layer on the current collector,
wherein the positive electrode active material layer comprises a positive electrode active material, a sulfide-based solid electrolyte, a fluorine-based binder, a lithium salt, and a dispersion medium, and
the dispersion medium includes a compound represented by Chemical Formula 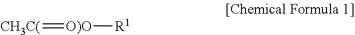
R¹ is a C7 to C9 alkyl group.

2. The positive electrode for an all-solid-state rechargeable battery as claimed in claim 1, wherein
the compound represented by the above Chemical Formula 1 is included in an amount of less than or equal to 0.1 wt % based on 100 wt % of the positive electrode active material layer.

3. The positive electrode for an all-solid-state rechargeable battery as claimed in claim 1, wherein
the lithium salt is included in an amount of 10 parts by weight to 60 parts by weight based on 100 parts by weight of the fluorine-based binder in the positive electrode active material layer.

4. The positive electrode for an all-solid-state rechargeable battery as claimed in claim 1, wherein
the lithium salt is included in an amount of 30 parts by weight to 50 parts by weight based on 100 parts by weight of the fluorine-based binder in the positive electrode active material layer.

5. The positive electrode for an all-solid-state rechargeable battery as claimed in claim 1, wherein
the fluorine-based binder comprises polyvinylidene fluoride (PVdF), a polyvinylidene fluoride-hexafluoropropylene (PVdF-HFP) copolymer, a polyvinylidene fluoride-trichloroethylene (PVdF-TCE) copolymer, polytetrafluoroethylene (PTFE), polytrifluoroethylene (PTrFE), polychlorotrifluoroethylene (CTFE), hexafluoropropylene, hexafluoroisobutylene, or a combination thereof.

6. The positive electrode for an all-solid-state rechargeable battery as claimed in claim 1, wherein
the fluorine-based binder is a polyvinylidene fluoride-hexafluoropropylene (PVdF-HFP) copolymer.

7. The positive electrode for an all-solid-state rechargeable battery as claimed in claim 6, wherein
the polyvinylidene fluoride-hexafluoropropylene (PVdF-HFP) copolymer comprises 70 to 99 mol % of a vinylidene fluoride unit and 1 to 30 mol % of a hexafluoropropylene unit.

8. The positive electrode for an all-solid-state rechargeable battery as claimed in claim 6, wherein
the polyvinylidene fluoride-hexafluoropropylene (PVdF-HFP) copolymer comprises 75 mol % to 85 mol % of a vinylidene fluoride unit and 15 mol % to 25 mol % of a hexafluoropropylene unit.

9. The positive electrode for an all-solid-state rechargeable battery as claimed in claim 1, wherein
the lithium salt comprises LiPF₆, LiBF₄, LiSbF₆, LiAsF₆, LiCsF₆, LiCl, LiF, LiBr, LiI, LiCF₃SO₃, LiClO₄, LiSCN, LiN(CN)₂, Li(CF₃SO₂)₃C, LiC₄F₉SO₃, LiN(SO₂CF₂CF₃)₂, LiB(C₂O₄)₂, LiBF₃(C₂F₅), lithium bis(oxalato) borate (LiBOB), lithium difluoro (oxalato) borate (LiDFOB), lithium bis(trifluoromethanesulfonyl)imide (LiTFSI), lithium bis(fluorosulfonyl)imide (LiFSI), or a combination thereof.

10. The positive electrode for an all-solid-state rechargeable battery as claimed in claim 1, wherein
the lithium salt is an imide-based lithium salt.

11. The positive electrode for an all-solid-state rechargeable battery as claimed in claim 10, wherein
the lithium salt comprises lithium bis(trifluoromethanesulfonyl)imide (LiTFSI), lithium bis(fluorosulfonyl)imide (LiFSI), or a combination thereof.

12. The positive electrode for an all-solid-state rechargeable battery as claimed in claim 1, wherein
the fluorine-based binder and the lithium salt are combined.

13. The positive electrode for an all-solid-state rechargeable battery as claimed in claim 1, wherein
65 to 99 wt % of the positive electrode active material and 1 to 35 wt % of the sulfide-based solid electrolyte are included, based on the total weight of the positive electrode active material and the sulfide-based solid electrolyte.

14. The positive electrode for an all-solid-state rechargeable battery as claimed in claim 1, wherein
the positive electrode active material comprises lithium cobalt oxide, lithium nickel oxide, lithium nickel cobalt oxide, lithium nickel cobalt aluminum oxide, lithium nickel cobalt manganese oxide, lithium nickel manganese oxide, lithium manganese oxide, lithium iron phosphate, or a combination thereof.

15. The positive electrode for an all-solid-state rechargeable battery as claimed in claim 1, wherein
the sulfide-based solid electrolyte comprises an argyrodite-type sulfide.

16. The positive electrode for an all-solid-state rechargeable battery as claimed in claim 1, wherein
an average particle diameter (D50) of the positive electrode active material is 3 μm to 25 μm, and
an average particle size (D50) of the sulfide-based solid electrolyte is 0.1 μm to 1.9 μm.

17. The positive electrode for an all-solid-state rechargeable battery as claimed in claim 1, wherein
the positive electrode active material layer comprises, based on 100 wt % of the positive electrode active material layer,
55 wt % to 99 wt % of the positive electrode active material,
0.5 wt % to 35 wt % of the sulfide-based solid electrolyte,
0.1 wt % to 5 wt % of the fluorine-based binder,
0.01 wt % to 3 wt % of the lithium salt,
0.001 wt % to 0.1 wt % of the dispersion medium, and
0 wt % to 3 wt % of a conductive material.

18. An all-solid-state rechargeable battery comprising a positive electrode, a negative electrode, and a solid electrolyte layer between the positive electrode as claimed in claim 1 and a negative electrode.

19. The all-solid-state rechargeable battery as claimed in claim 18, wherein
the negative electrode comprises a current collector and a negative electrode coating layer located on the current collector and including a lithiophilic metal, a carbon material, or a combination thereof, and
a lithium metal layer formed by charging between the collector and the negative electrode coating layer.
